(19) United States
(12) Patent Application Publication
(10) Pub. No.: US 2010/0034461 A1
(43) Pub. Date: Feb. 11, 2010

(54) METHOD AND APPARATUS FOR GENERATING MEDIA SIGNAL

(75) Inventor: Kuk-hyun HAN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/431,164

(22) Filed: Apr. 28, 2009

(30) Foreign Application Priority Data
Aug. 11, 2008 (KR) 10-2008-0078518

(51) Int. Cl. G06K 9/34; G06F 3/00

(52) U.S. Cl. 382/177; 715/717

(57) ABSTRACT

A method of generating a media signal is provided. The method detects a pattern indicating a request for a media signal to be generated from an input image, extracts a region identified by the detected pattern and generates the media signal for the extracted region.

### CROSS-REFERENCE TO RELATED PATENT APPLICATION

This application claims priority from Korean Patent Application No. 10-2008-0078518, filed on Aug. 11, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to generating a media signal, and more particularly, to generating a media signal for a region identified by a predetermined pattern using a camera.

2. Description of the Related Art

A variety of digital apparatuses are widely provided due to the development of technology. Thus, a user can input desired information to a digital apparatus using an input device, such as a remote control, a mouse, a keyboard, a touch screen and so on, or select desired information displayed on a screen of the digital apparatus. Furthermore, the user can transmit information stored in the digital apparatus to an external server or an external terminal using a wired or wireless communication network.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a method and an apparatus for generating a media signal for a region identified by a predetermined pattern.

According to an aspect of the present invention, there is provided a method of generating a media signal, which includes detecting a pattern requesting a media signal to be generated from an input image, extracting a region identified by the detected pattern, and generating a media signal for the extracted region.

The detecting of the pattern may include comparing the pattern included in the input image with previously stored media signal request patterns and determining whether the pattern included in the input image corresponds to a media signal request pattern. The pattern may include a predetermined sign and a predetermined action and the predetermined sign may include at least one of a bracket and a figure.

The method may further include transmitting the media signal to an external terminal or an external server through a communication network.

The method may further include outputting the state of transmission of the media signal to the external terminal or the external server as graphic information. The graphic information may include first identification information used to identify the external terminal, the external server, or a user of the external terminal. The graphic information may include second identification information used to identify a media signal generating apparatus or a user of the media signal generating apparatus, and transmission state information representing that the media signal is being transmitted from the media signal generating apparatus or the user of the media signal generating apparatus that is identified by the second identification information to the external terminal, the external server or the external terminal user identified by the first identification information. Each of the first identification information, the second identification information and the transmission state information may include at least one of characters, a sign and image information, and the image information may include at least one of an emoticon, an icon, a flash icon and image information.

The method may further include displaying the media signal on a screen of the media signal generating apparatus. The detecting of the pattern may include detecting a first pattern from the input image and detecting a second pattern corresponding to the first pattern from the input image. The extracting of the identified region may include extracting a region defined by positions of the first and second patterns. The extracting of the identified region may include extracting a rectangular region having a straight line connecting the first pattern and the second pattern as a diagonal line. The extracting of the identified region may include extracting a region defined by position and direction of the pattern. The extracting of the identified region may include extracting a region which can be variable in vertical and horizontal directions about the position of the pattern depending on the direction of the pattern.

When the pattern corresponds to an angle bracket, the extracting of the identified region may include extracting a rectangular region having a straight line connecting the center point of the angle bracket to a corner of a region located between two straight lines that extend from two lines that are elements of the angle bracket from the center point, as a diagonal line. When the pattern corresponds to a curved line, the extracting of the identified region may include extracting a rectangular region having a straight line connecting the center point of the curved line to a corner of a region located between two straight lines that extend from two lines connecting each of the two end points of the curved line to the center point as a diagonal line. The generating of the media signal may include generating a media signal in the form of an image file or a media signal in the form of a text file from the input image. The generating of the media signal may include extracting second information corresponding to first information included in the identified region and generating the media signal using the second information.

According to another aspect of the present invention, there is provided an apparatus for generating a media signal, which includes a pattern detector detecting a pattern requesting a media signal to be generated from an input image, a region extractor extracting a region identified by the detected pattern, and a media signal generator generating a media signal for the extracted region.

According to another aspect of the present invention, there is provided a computer readable recording medium storing a program for executing a method of generating a media signal, which includes detecting a pattern requesting a media signal to be generated from an input image, extracting a region identified by the detected pattern, and generating a media signal for the extracted region.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram for explaining a method of generating a media signal, according to an exemplary embodiment of the present invention;

FIG. 2 is a block diagram of a media signal generating apparatus according to an exemplary embodiment of the present invention;

FIGS. 3A and 3B illustrate media signals generated from images input to the media signal generating apparatus illustrated in FIG. 2, according to an exemplary embodiment of the present invention;

FIGS. 4A and 4B illustrate media signals generated from images input to the media signal generating apparatus illustrated in FIG. 2, according to an exemplary embodiment of the present invention;

FIGS. 5A and 5B illustrate media signals generated from images input to the media signal generating apparatus illustrated in FIG. 2, according to an exemplary embodiment of the present invention;

FIG. 6 illustrates graphic information representing that a media signal is being transmitted to an external terminal or an external server when the media signal generating apparatus of FIG. 5 transmits the media signal to the external device or the external server, according to an exemplary embodiment of the present invention; and

FIG. 7 is a flowchart of a method of generating a media signal, according to an exemplary embodiment of the present invention.

### DETAILED DESCRIPTION OF EXEMPLARY EMBODIMENTS

Exemplary embodiments of the present invention will now be explained in detail with reference to the attached drawings.

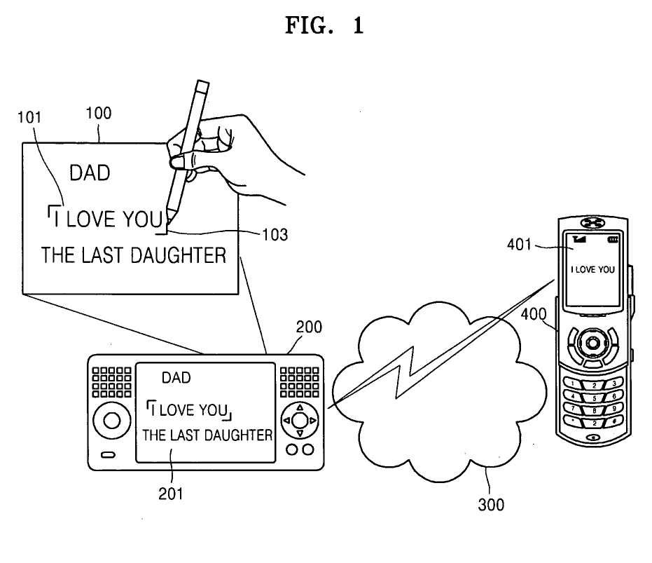

FIG. 1 is a schematic diagram for explaining a method of generating a media signal, according to an exemplary embodiment of the present invention. Referring to FIG. 1, the method of generating a media signal, according to an exemplary embodiment of the present invention, is performed using a media signal generating apparatus 200. If required, the method of generating a media signal may be carried out using the media signal generating apparatus 200, a wired or wireless communication network 300, and an external terminal 400.

The media signal generating apparatus 200 can take a photograph of an object to generate a media signal and may be a personal digital assistant (PDA), a portable multimedia player (PMP), a cellular phone, or a navigation system, which has a camera function, a camcorder, and a camera, or a notebook computer including an ultra mobile personal computer (UMPC). In FIG. 1, a UMPC is shown as being used as the media signal generating apparatus 200.

A user can input desired information to the media signal generating apparatus 200 by using a camera instead of a keyboard or a keypad. The media signal generating apparatus 200 captures an image, corresponding to the information desired to be input by the user, with a camera. In FIG. 1, the user has handwritten or drawn on an arbitrary plane 100 to generate desired information. The user forms predetermined patterns 101 and 103 (referred to as media signal request patterns) that request a media signal to be generated for information existing on the arbitrary plane 100, such as text or a picture, and the text or the picture can be written or drawn by the user personally. In exemplary embodiments of the present invention, media signal request patterns correspond to information representing a region which the user wants to generate a media signal from among an image 201 input to the media signal generating apparatus 200.

Media signal request patterns are stored in the media signal generating apparatus 200. The media signal request patterns can include brackets and parentheses in various forms, signs, figures, and predetermined actions. In FIG. 1, the media signal generating apparatus 200 detects the patterns 101 and 103, “ [symbol] ” and “ [symbol] ”, from the input image 201. The media signal generating apparatus 200 compares the detected patterns 101 and 103 to the medial signal request patterns previously stored therein and extracts a predetermined closed region identified by the patterns 101 and 103 when it is determined that the patterns 101 and 103 of the input image 201 correspond to the media signal request patterns.

The media signal generating apparatus 200 generates a media signal for the extracted region. The media signal generating apparatus 200 can capture the region identified by the patterns 101 and 103 in the input image 201 to generate a media signal in the form of an image file. Furthermore, the media signal generating apparatus 200 can convert characters included in the identified region into a text file to generate a media signal in the form of a text file.

The media signal generating apparatus 200 can display the generated media signal on a screen thereof or transmit the media signal to an external server or the external terminal 400 through the wired or wireless communication network 300. The external terminal 400 can communicate with the media signal generating apparatus 200 through a communication network and may be a PDA, a PMP, a cellular phone, a navigation system, or a notebook computer including a UMPC. FIG. 1 illustrates a cellular phone being used as the external terminal 400.

As described above, according to an exemplary embodiment of the present invention, the user can input desired information to the media signal generating apparatus 200 using the camera instead of an input device such as a keyboard or a keypad.

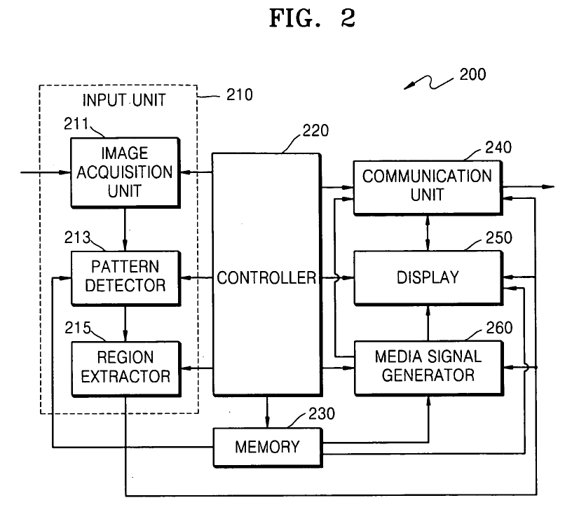

FIG. 2 is a block diagram of the media signal generating apparatus 200 according to an exemplary embodiment of the present invention. Referring to FIG. 2, the media signal generating apparatus 200 includes an input unit 210, a controller 220, a memory 230, a communication unit 240, a display 250 and a media signal generator 260.

The media signal generating apparatus 200 may further include a user interface (not shown). The user interface transmits commands, characters, numbers or audio information received from the user to the controller 220.

The input unit 210 receives an image input through a camera or other device providing the image. The media signal generating apparatus 200 can receive information through other methods, in addition to a method of acquiring an image using the camera. In this case, the input unit 210 can include physical transducers such as a keyboard, a mouse, a touch pad, a touch screen and a microphone, in addition to the camera. The user can select whether to input information using a camera or a keyboard through the user interface. The input unit 210 can also function as a user interface for transmitting an instruction of the user to the controller 220 according to circumstances.

The input unit 210 includes an image acquisition unit 211, a pattern detector 213 and a region extractor 215. The image acquisition unit 211 acquires an image input through a camera lens and sends the received image to the pattern detector 213. The pattern detector 213 determines whether the image transmitted from the image acquisition unit 211 includes a media signal request pattern. The media signal request pattern may include brackets, signs, figures, and predetermined actions. Specifically, the media signal request pattern can include at least one of brackets such as angle brackets, parentheses, braces and square brackets, quotation marks such as double quotation marks, single quotation marks, corner brackets and double corner brackets, signs and figures such as a cross or a clover, but is not limited to these examples.

The media signal request pattern can include a predetermined action of the user. For example, when the user draws a circle around letters or a picture with a finger or a pen, this action can be a predetermined pattern for requesting a media signal to be generated for the image surrounded by the circle. When the pattern corresponds to a predetermined action, the pattern detector 213 determines whether the action forming the predetermined pattern has been performed for a predetermined period of time.

The pattern detector 213 determines whether the input image includes a media signal request pattern stored in the memory 230, detects the pattern when it is determined that the input image includes the media signal request pattern stored in the memory 230 and sends the detected pattern to the region extractor 215.

The region extractor 215 extracts a region identified by the detected pattern. The media signal request pattern can be represented as one of a pair of parentheses or quotation marks forming a closed section. When two patterns forming the parenthesis pair or quotation mark pair are referred to as a first pattern and a second pattern, if the first pattern is detected from the input image, the pattern detector 213 determines whether the input image also includes the second pattern corresponding to the first pattern. When the input image includes both the first and second patterns, the region extractor 215 extracts the closed section designated by the positions of the first and second patterns as a region identified by the first and second patterns. For example, the region extractor 215 can extract a rectangular region having a straight line that connects the center points of the first and second patterns as a diagonal line as an identified region.

When the input image includes the first pattern and does not include the second pattern, the region extractor 215 can extract a region defined by the position and direction of the detected first pattern as an identified region. The region extractor 215 transmits the extracted region to the media signal generator 260.

The media signal generator 260 generates a media signal for the region extracted by the region extractor 215 among the image input through the image acquisition unit 211. The media signal can include at least one of a video signal, an audio signal and a text signal. The media signal generator 260 can generate a media signal in the form of an image file corresponding to the image of the extracted region. When the image of the extracted region includes characters, the media signal generator 260 can convert the characters into a corresponding figure or a text signal to generate a media signal. The media signal generator 260 transmits the generated media signal to the display 250 or the communication unit 240.

The memory 230 stores media signal request patterns, information on figures corresponding to characters included in media signals, graphic information for graphics to be displayed on the display 250 when media signals are transmitted to an external terminal or an external server, and programs required to perform the method of generating a media signal according to an exemplary embodiment of the present invention. The graphic information can include identification information used to identify the external terminal, the external server or an external terminal user and transmission state information representing the state of transmission of a media signal from the media signal generating apparatus 200 to the external terminal 400 or the external server. The graphic information can include at least one of characters, a sign and image information. The image information can include at least one of an emoticon, an icon, a flash icon and image information.

The memory 230 can include a high-speed main memory such as random access memory (RAM) or read only memory (ROM), an auxiliary memory in the form of a long-term storage medium, such as a floppy disk, a hard disk, tape, a CD-ROM and a flash memory, and a device storing data using an electric storage medium, a magnetic storage medium, an optical storage medium and other storage media.

The controller 220 controls the overall operation of the media signal generating apparatus 200 at the request of the user. The controller 220 controls the input unit 210 to detect a media signal request pattern from an input image and controls the media signal generator 260 to generate a media signal for a region identified by the detected pattern. The controller 220 controls the communication unit 240 to transmit the media signal to the external server or the external terminal 400 and controls the display 250 to output graphic information that represents the state of transmission of the media signal to the server or the external terminal 400. The controller 220 includes an arithmetic logic unit (ALU) for performing computations and a register for temporarily storing data and commands.

The display 250 displays the overall state of the media signal generating apparatus 200 or an image input through the input unit 210. The display 250 can output a media signal generated by the media signal generating apparatus 200. When the media signal generating apparatus 200 transmits a generated media signal to the external terminal 400 at the request of the user, the display 250 can output information identifying the media signal generating apparatus 200, information identifying the external terminal 400 or server and information representing the state of transmission of predetermined information from the media signal generating apparatus 200 to the external terminal 400 or server using the graphic information stored in the memory 230. The display 250 generates a user control list and outputs the user control list as on-screen display (OSD) information.

The communication unit 240 can transmit the media signal to the external server or the user terminal 400 using the wired or wireless communication network 300. When the communication unit 240 performs a communication operation according to a wireless communication method, the communication unit 240 can include a radio signal transceiver (not shown), a base band processor (not shown) and a link controller (not shown). The base band processor and the link controller may be connected to the controller 220 according to host control interface (HCI) and transmit/receive HCI packets to send and receive control commands and transmission/receiving data. A WLAN, Bluetooth, Zigbee, Wibro, or the like may be used as the wireless communication method.

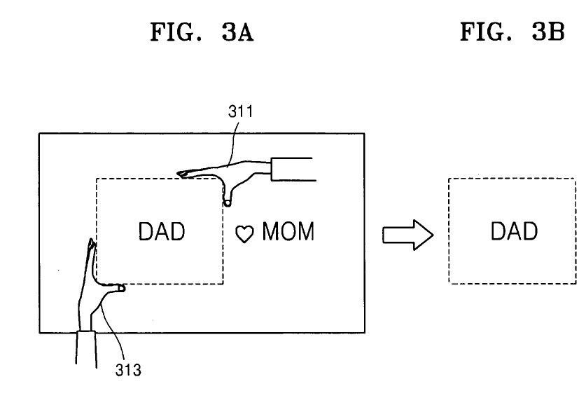

FIGS. 3A, 3B, 4A, 4B, 5A and 5B illustrate media signals generated from images input to the media signal generating apparatus 200 illustrated in FIG. 2, according to exemplary embodiments of the present invention. FIG. 3A illustrates an example of an image input to the input unit 210 of the media signal generating apparatus 200 illustrated in FIG. 2. A user marks a region of the input image, for which the user wants to generate a media signal, with a predetermined pattern. Referring to FIGS. 3A and 3B, when the user wants to input only “DAD” in “DAD [symbol] MOM” to the media signal generating apparatus 200 to generate a media signal, the user generates media signal request patterns 311 and 313 used to identify the characters “DAD.” The user forms angle brackets with his/her hands as the media signal request patterns 311 and 313 to mark the region for which a media signal will be generated.

The media signal generating apparatus 200 illustrated in FIG. 2 determines whether the media signal request patterns 311 and 313 included in the input image correspond to media signal request patterns previously stored in the memory 230. When the media signal generating apparatus 200 determines that one of the two media signal request patterns 311 and 313 included in the input image corresponds to a media signal request pattern, the media signal generating apparatus 200 determines whether the other media signal request pattern corresponding to the determined media signal request pattern is included in the input image. When the media signal generating apparatus 200 detects the other media signal request pattern in the input image, the media signal generating apparatus 200 extracts a region identified by the two media signal request patterns. For example, the media signal generating apparatus 200 can extract a rectangular region having a straight line that connects the two patterns as a diagonal line as the region identified by the two patterns.

In FIG. 3A, the region identified by the media signal request patterns 311 and 313 is denoted by a dotted line. The media signal generating apparatus 200 illustrated in FIG. 2 generates a media signal for the region identified by the media signal request patterns 311 and 313. The media signal generating apparatus 200 can generate a media signal in the form of an image file about the characters input by the user for the region identified by the media signal request patterns 311 and 313. Furthermore, the media signal generating apparatus 200 can convert the characters “DAD” into a text signal, such as a text signal input through a keyboard or a keypad, to generate a text media signal.

FIG. 3B illustrates a media signal displayed on the display 250 of the media signal generating apparatus 200 or transmitted to an external server or an external terminal and output on the server or external terminal.

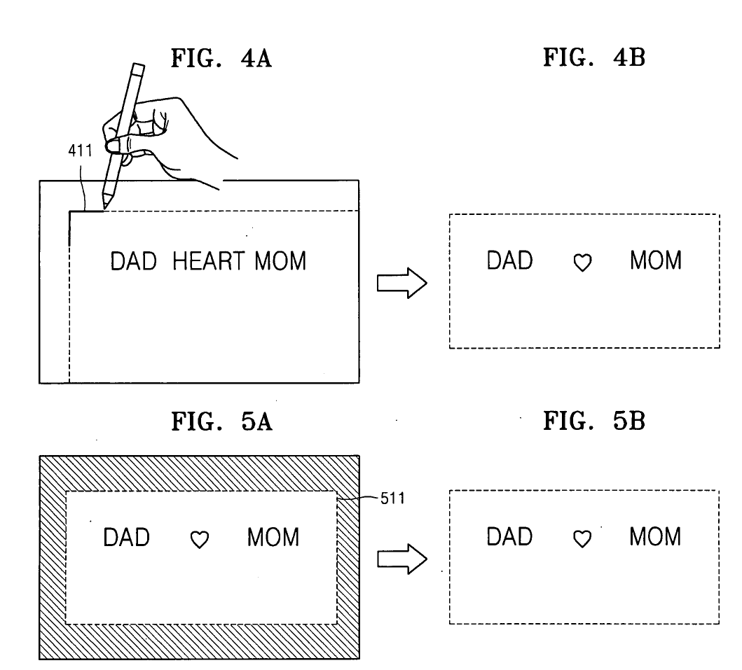

FIG. 4A illustrates another example of an image input to the input unit 210 of the media signal generating apparatus 200 illustrated in FIG. 2. The user marks a region of the input image, for which the user wants to generate a media signal, with a predetermined pattern. Referring to FIG. 4A, the user marks the region with an angle bracket pattern 411 by using a writing instrument.

The media signal generating apparatus 200 illustrated in FIG. 2 can convert characters or a picture included in an input image to a figure corresponding to the characters or the picture, and generate a media signal including the figure. The media signal generating apparatus 200 determines whether the input image includes information that can be converted to its corresponding characters, figure or picture using information stored in the memory 230. When the input image includes the information, the media signal generating apparatus 200 can convert the information included in the input image into its corresponding information stored in the memory 230, and generate a media signal including the converted information. As shown in FIGS. 4A and 4B, the media signal generating apparatus 200 converts “HEART” in “DAD HEART MOM” included in the input image into a figure [symbol] and generates a media signal “DAD [symbol] MOM” including the figure [symbol] .

The media signal generating apparatus 200 illustrated in FIG. 2 determines whether the angle bracket pattern 411 included in the input image corresponds to a media signal request pattern previously stored in the memory 230. When the angle bracket pattern 411 included in the input image corresponds to a media signal request pattern previously stored in the memory 230 and the angle bracket pattern 411 corresponds to a figure such as a circle enveloping a predetermined region of the input image so that the media signal generating apparatus 200 can identify the predetermined region only with the single media signal request pattern previously stored in the memory 230, the media signal generating apparatus 200 generates a media signal for an image of the predetermined region identified by the media signal request pattern.

However, when a media signal request pattern corresponds to one of a pair of restriction marks forming a closed section, such as brackets or quotation marks, the media signal generating apparatus 200 detects one pattern from an input image, and then determines whether the other pattern corresponding to the detected pattern is included in the input image. If only one of the two patterns forming a closed section is included in the input image, the media signal generating apparatus 200 can extract a predetermined region only using the detected pattern. That is, the media signal generating apparatus 200 can extract a region defined by the position and direction of the angle bracket pattern 411 as a region identified by the angle bracket pattern 411.

Referring to FIG. 4A, the input image includes only one angle bracket pattern 411, and thus the media signal generating apparatus 200 extracts the region surrounded by the angle bracket pattern 411 based on the position of the angle bracket pattern 411 as the region identified by the angle bracket pattern 411. In an exemplary embodiment of the present invention, a rectangular region having a straight line connecting the center point of the angle bracket pattern 411 to a corner of a region located between two lines that extend from the center point as a diagonal line can be extracted as the region identified by the angle bracket pattern 411.

FIG. 4B illustrates the rectangular region identified by the media signal generating apparatus 200 using the angle bracket pattern 411. The media signal generating apparatus 200 can output the image illustrated in FIG. 4B through the display 250 or transmit the image to the external terminal or server.

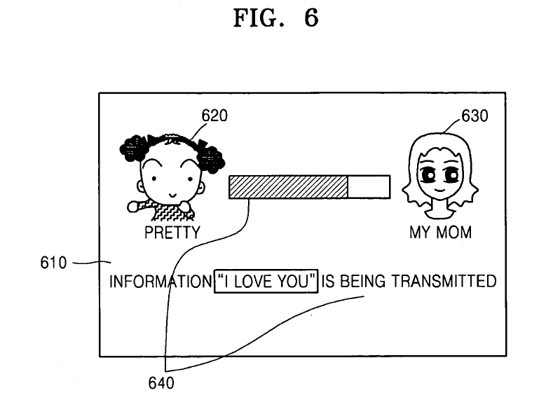

FIG. 5A illustrates another example of an image input to the input unit 210 of the media signal generating apparatus 200 illustrated in FIG. 2. In FIG. 5A, the user defines a region for which the user wants to generate a media signal by putting a paper of the region on another paper with a color different from that of the paper. That is, when the user writes “DAD [symbol] MOM” on white memo paper and puts the white memo paper on another paper with a different color to white, the media signal generating apparatus 200 can detect a white region from the input image and generate a media signal only for the detected white region, as illustrated in FIG. 5B.

FIG. 6 illustrates graphic information representing that a media signal is being transmitted to the external terminal 400 or server when the media signal generating apparatus 200 illustrated in FIG. 2 transmits the media signal to the external terminal 400 or server. The media signal generating apparatus 200 can generate the media signal, and then transmit the generated media signal to the external terminal 400 or server at the user's request or automatically. The media signal generating apparatus 200 can display on the display 250 first identification information for identifying the external terminal 400, the user of the external terminal 400 or the external server, second identification information for identifying the media signal generating apparatus 200, and graphic information such as transmission state information representing that the media signal is being transmitted from the media signal generating apparatus 200 to the external terminal 400 or server. In this case, the information for identifying the media signal generating apparatus 200 or the external terminal 400 can be an emoticon, an icon, a flash icon, image information, such as a picture or a moving image, characters, or a sign, but is not limited to these examples. FIG. 6 illustrates an image displayed on the display 250 of the media signal generating apparatus 200 illustrated in FIG. 2. In FIG. 6, the characters “PRETTY” and an emoticon 620 in the form of an avatar are used as the second identification information for identifying the media signal generating apparatus 200. In addition, the characters “MY MOM” and an avatar emoticon 630 are used as the first identification information for identifying the external terminal 400, and characters and a bar 640 are used as the transmission state information representing that information “I LOVE YOU” is being transmitted from the media signal generating apparatus 200 to the external terminal 400. Thus, the user of the media signal generating apparatus 200 can realize that predetermined information is being transmitted to the user of the external terminal 400 using the graphic information displayed on the display 250 in an easy and interesting manner.

As described above, the media signal generating apparatus 200 according to an exemplary embodiment of the present invention can display information representing that a media signal is being transmitted to a predetermined recipient using an emoticon that the user prefers.

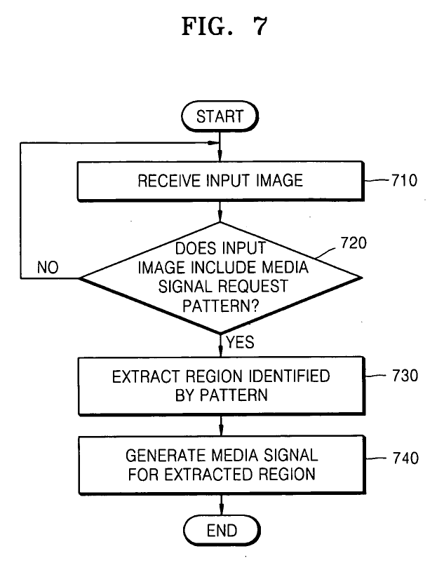

FIG. 7 is a flowchart of a method of generating a media signal, according to an exemplary embodiment of the present invention. Referring to FIG. 7, the media signal generating apparatus 200 illustrated in FIG. 2 captures an image in operation 710, and determines whether the input image includes a media signal request pattern, in operation 720. The media signal generating apparatus 200 illustrated in FIG. 2 extracts a region identified by the media signal request pattern when the input image includes the media signal request pattern, in operation 730, and generates a media signal for the extracted region, in operation 740.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating a media signal, the method comprising:
detecting a pattern indicating a request for a media signal to be generated from an input image;
extracting a region identified by the detected pattern; and
generating the media signal for the extracted region.

2. The method of claim 1, wherein the detecting the pattern comprises comparing the pattern which is included in the input image with stored media signal request patterns and determining whether the pattern included in the input image corresponds to one of the stored media signal request patterns.

3. The method of claim 1, wherein the pattern comprises a predetermined sign and a predetermined action, and the predetermined sign comprises at least one of a bracket and a figure.

4. The method of claim 1, further comprising transmitting the media signal to an external terminal or an external server, through a communication network.

5. The method of claim 4, further comprising outputting a state of transmission of the media signal as graphic information to the external terminal or the external server.

6. The method of claim 5, wherein the graphic information comprises first identification information which identifies the external terminal, the external server, or a user of the external terminal.

7. The method of claim 6, wherein the graphic information further comprises second identification information which identifies a media signal generating apparatus or a user of the media signal generating apparatus, and transmission state information representing that the media signal is being transmitted from the media signal generating apparatus or the user of the media signal generating apparatus that is identified by the second identification information to the external terminal, the external server or the external terminal user identified by the first identification information.

8. The method of claim 7, wherein each of the first identification information, the second identification information and the transmission state information comprises at least one of characters, a sign, and image information, and the image information comprises at least one of an emoticon, an icon, a flash icon, and image information.

9. The method of claim 1, further comprising displaying the media signal on a screen.

10. The method of claim 1, wherein the detecting the pattern comprises:
detecting a first pattern from the input image; and
detecting a second pattern corresponding to the first pattern from the input image.

11. The method of claim 10, wherein the extracting the identified region comprises extracting a region defined by positions of the first and second patterns.

12. The method of claim 11, wherein the extracting the identified region comprises extracting a rectangular region having a straight line connecting the first pattern and the second pattern as a diagonal line.

13. The method of claim 1, wherein the extracting the identified region comprises extracting a region defined by a position and a direction of the pattern.

14. The method of claim 13, wherein the extracting the identified region comprises extracting a region which is variable in vertical and horizontal directions about the position of the pattern depending on the direction of the pattern.

15. The method of claim 13, wherein, if the pattern corresponds to an angle bracket, the extracting the identified region comprises extracting a rectangular region having a straight line connecting a center point of the angle bracket to a corner of an area located between two straight lines that extend from two lines that are elements of the angle bracket from the center point, as a diagonal line.

16. The method of claim 13, wherein, if the pattern corresponds to a curved line, the extracting the identified region comprises extracting a rectangular region having a straight line connecting a center point of the curved line to a corner of an area located between two straight lines that extend from two lines connecting each of two end points of the curved line to the center point, as a diagonal line.

17. The method of claim 1, wherein the generating the media signal comprises generating the media signal as an image file or a text file, from the input image.

18. The method of claim 17, wherein the generating the media signal comprises:
extracting second information from a media signal generating apparatus, the second information corresponding to first information included in the identified region; and
generating the media signal using the second information.

19. An apparatus for generating a media signal comprising:
a pattern detector which detects a pattern indicating a request for a media signal to be generated from an input image;
a region extractor which extracts a region identified by the detected pattern; and
a media signal generator which generates the media signal for the extracted region.

20. The apparatus of claim 19, wherein the pattern detector compares the pattern which is included in the input image with stored media signal request patterns and determines whether the pattern included in the input image corresponds to one of the stored media signal request patterns.

21. The apparatus of claim 19, wherein the pattern comprises a predetermined sign and a predetermined action and the predetermined sign comprises at least one of a bracket and a figure.

22. The apparatus of claim 19, further comprising a communication unit which transmits the media signal to an external terminal or an external server through a communication network.

23. The apparatus of claim 22, further comprising a display which outputs the media signal or a state of transmission of the media signal as graphic information to the external terminal or the external server.

24. The apparatus of claim 23, wherein the graphic information comprises first identification information which identifies the external terminal, the external server or a user of the external terminal.

25. The apparatus of claim 24, wherein the graphic information further comprises second identification information which identifies the apparatus or a user of the apparatus, and transmission state information representing that the media signal is being transmitted from the apparatus or the user of the apparatus that is identified by the second identification information to the external terminal, the external server or the user of the external terminal that is identified by the first identification information.

26. The apparatus of claim 25, wherein each of the first identification information, the second identification information and the transmission state information comprise at least one of characters, a sign, and image information, and the image information comprises at least one of an emoticon, an icon, a flash icon, and image information.

27. The apparatus of claim 19, wherein the pattern detector detects a first pattern from the input image and then detects a second pattern corresponding to the first pattern from the input image.

28. The apparatus of claim 27, wherein the region extractor extracts a region defined by the positions of the first and second patterns.

29. The apparatus of claim 28, wherein the region extractor extracts a rectangular region having a straight line connecting the first pattern and the second pattern as a diagonal line.

30. The apparatus of claim 19, wherein the region extractor extracts a region defined by a position and a direction of the pattern.

31. The apparatus of claim 30, wherein the region extractor extracts a region which is variable in vertical and horizontal directions about the position of the pattern depending on the direction of the pattern.

32. The apparatus of claim 30, wherein, when the pattern corresponds to an angle bracket, the region extractor extracts a rectangular region having a straight line connecting a center point of the angle bracket to a corner of an area located between two straight lines that extend from two lines that are elements of the angle bracket from the center point, as a diagonal line.

33. The apparatus of claim 30, wherein, if the pattern corresponds to a curved line, the extracting the identified region comprises extracting a rectangular region having a straight line connecting a center point of the curved line to a corner of an area located between two straight lines that extend from two lines connecting each of two end points of the curved line to the center point, as a diagonal line.

34. The apparatus of claim 19, wherein the media signal generator generates the media signal as an image file or as a text file, from the input image.

35. The apparatus of claim 34, wherein the media signal generator extracts second information from the apparatus, the second information corresponding to first information included in the identified region and generates the media signal using the second information.

36. A computer readable recording medium storing a program for executing a method of generating a media signal, the method comprising:
detecting a pattern indicating a request for a media signal to be generated from an input image;
extracting a region identified by the detected pattern; and
generating the media signal for the extracted region.

37. A method of generating a media signal, the method comprising:
detecting a request pattern;
extracting a region of an input image based on the detected request pattern;
generating a media signal from the extracted region; and
displaying the media signal as an image on a display device.

38. The method of claim 37, wherein the detected request pattern is located within the input image.

39. The method of claim 37, wherein the detected request pattern comprises an action of a user.

40. The method of claim 39, wherein the action of the user comprises generating an indicator relative to the input image, and the indicator indicate a location of the region of the input image to be extracted.

41. The method of claim 37, wherein the detecting the request pattern comprises determining that the input image includes a pattern corresponding to a stored media signal request pattern.
